(19) United States
(12) Patent Application Publication
(10) Pub. No.: US 2025/0292528 A1
(43) Pub. Date: Sep. 18, 2025

(54) INFORMATION PROCESSING APPARATUS, METHOD, AND PROGRAM

(71) Applicant: FUJIFILM CORPORATION, Tokyo (JP)

(72) Inventor: Masahiro SAKURAI, Kanagawa (JP)

(21) Appl. No.: 19/056,758

(22) Filed: Feb. 19, 2025

(30) Foreign Application Priority Data
Mar. 15, 2024 (JP) 2024-041683

(51) Int. Cl. G06V 10/25; G06T 5/40; G06T 5/94; G06V 10/26

(52) U.S. Cl. CPC G06V 10/25; G06T 5/40; G06T 5/94; G06V 10/273; G06T 2207/10121; G06T 2207/20081; G06T 2207/30004; G06V 2201/03

(57) ABSTRACT

Provided is an information processing apparatus in a fluoroscopy apparatus equipped with an optical camera that acquires a fluoroscopic image by performing fluoroscopy on a subject and acquires an optical image of the subject, and a processor specifies a region of interest included in the optical image, sets an image processing condition for improving an image quality of a region in the fluoroscopic image corresponding to the region of interest, and performs image processing on the fluoroscopic image based on the image processing condition.

### CROSS REFERENCE TO RELATED APPLICATIONS

The present application claims priority from Japanese Patent Application No. 2024-041683, filed on Mar. 15, 2024, the entire disclosure of which is incorporated herein by reference.

### BACKGROUND

### Technical Field

The present disclosure relates to an information processing apparatus, method, and program.

### Related Art

In surgical operations and catheter treatment, it is necessary to ascertain a positional relationship between operation instruments and human body structures such as bones and blood vessels. Therefore, during operation, a subject is imaged by a fluoroscopy apparatus, and the positional relationship between the operation instrument and the human body structure is ascertained using a fluoroscopic image of radiation displayed on a display by the imaging.

Meanwhile, a method has been proposed in which, in the case of acquiring a radiation image of a subject, an optical image of the subject is acquired using an optical camera in addition to radiography, parts of the subject included in the optical image are recognized, and imaging conditions for radiography according to the recognized parts or image processing conditions for the acquired radiation image are set (see, for example, JP2023-090285A and JP2021-191402A).

During surgery using the above-mentioned fluoroscopy apparatus, the arm or hand of the surgeon may be captured in the fluoroscopic image. In such a case, the fluoroscopic image includes a region of interest, which is the region of the part to be a target of operation, and unnecessary regions, such as the surgeon's arm. In the methods described in JP2023-090285A and JP2021-191402A, the subject included in the optical image is specified, but in a case in which an unnecessary subject such as the surgeon's arm is included in the fluoroscopic image, it is difficult to set image processing conditions or imaging conditions that will result in appropriate image quality for the region of interest.

### SUMMARY OF THE INVENTION

The present disclosure has been made in consideration of the above circumstances, and an object of the present disclosure is to make it possible to acquire a high-image quality fluoroscopic image including a region of interest even in a case in which a fluoroscopic image includes an unnecessary subject region.

According to an aspect of the present disclosure, there is provided an information processing apparatus in a fluoroscopy apparatus equipped with an optical camera that acquires a fluoroscopic image by performing fluoroscopy on a subject and acquires an optical image of the subject, the information processing apparatus comprising: at least one processor, in which the processor is configured to: specify a region of interest included in the optical image; set an image processing condition for improving an image quality of a region in the fluoroscopic image corresponding to the region of interest; and perform image processing on the fluoroscopic image based on the image processing condition.

In the information processing apparatus according to the aspect of the present disclosure, the processor may be configured to: determine whether or not the optical image includes another subject region other than the region of interest; and in a case in which it is determined that the optical image includes the other subject region, specify the region of interest included in the optical image, set the image processing condition, and perform the image processing.

In the information processing apparatus according to the aspect of the present disclosure, the processor may be configured to: segment the optical image using a trained model that has been trained to segment the optical image; and use a result of the segmentation to determine whether or not the other subject region is included and to specify the region of interest.

In the information processing apparatus according to the aspect of the present disclosure, the other subject region may include a part of a body region of a surgeon who performs a treatment on the subject.

In the information processing apparatus according to the aspect of the present disclosure, the processor may be configured to, in a case in which it is determined that the optical image includes only one subject region, specify the one subject region as the region of interest, set the image processing condition, and perform the image processing.

In the information processing apparatus according to the aspect of the present disclosure, the image processing condition may be an image processing condition for improving a contrast of the region of interest included in the fluoroscopic image.

In the information processing apparatus according to the aspect of the present disclosure, the processor may be configured to: set an imaging condition for improving the image quality of the region in the fluoroscopic image corresponding to the region of interest in the case of performing the fluoroscopy; and perform the fluoroscopy based on the imaging condition.

In the information processing apparatus according to the aspect of the present disclosure, the imaging condition may be an imaging condition for improving a contrast of the region of interest included in the fluoroscopic image.

In the information processing apparatus according to the aspect of the present disclosure, the processor may be configured to display, on a display, a processed fluoroscopic image on which the image processing is performed.

According to another aspect of the present disclosure, there is provided an information processing method in a fluoroscopy apparatus equipped with an optical camera that acquires a fluoroscopic image by performing fluoroscopy on a subject and acquires an optical image of the subject, the information processing method comprising, by a computer: specifying a region of interest included in the optical image; setting an image processing condition for improving an image quality of a region in the fluoroscopic image corresponding to the region of interest; and performing image processing on the fluoroscopic image based on the image processing condition.

According to still another aspect of the present disclosure, there is provided an information processing program causing a computer to execute information processing in a fluoroscopy apparatus equipped with an optical camera that acquires a fluoroscopic image by performing fluoroscopy on a subject and acquires an optical image of the subject, the information processing program causing the computer to execute: a procedure of specifying a region of interest included in the optical image; a procedure of setting an image processing condition for improving an image quality of a region in the fluoroscopic image corresponding to the region of interest; and a procedure of performing image processing on the fluoroscopic image based on the image processing condition.

According to the aspects of the present disclosure, even in a case in which a fluoroscopic image includes an unnecessary subject region, a high-image quality fluoroscopic image including a region of interest can be acquired.

### BRIEF DESCRIPTION OF THE DRAWINGS

FIG. 1 is a diagram showing an overview of a fluoroscopy system including a fluoroscopy apparatus equipped with an information processing apparatus according to an embodiment of the present disclosure.

FIG. 2 is a diagram showing a schematic configuration of the information processing apparatus according to the present embodiment.

FIG. 3 is a diagram showing a functional configuration of the information processing apparatus according to the present embodiment.

FIG. 4 is a diagram showing an optical image including only a subject region of a foot.

FIG. 5 is a diagram showing an optical image including subject regions of the foot and an arm of a surgeon.

FIG. 6 is a diagram showing a map in which a foot region is masked.

FIG. 7 is a diagram showing a fluoroscopic image including regions of the foot and the arm of the surgeon.

FIG. 8 is a diagram showing a fluoroscopic image in which a foot region is specified.

FIG. 9 is a diagram showing a display screen.

FIG. 10 is a flowchart showing a process performed in the present embodiment.

### DETAILED DESCRIPTION

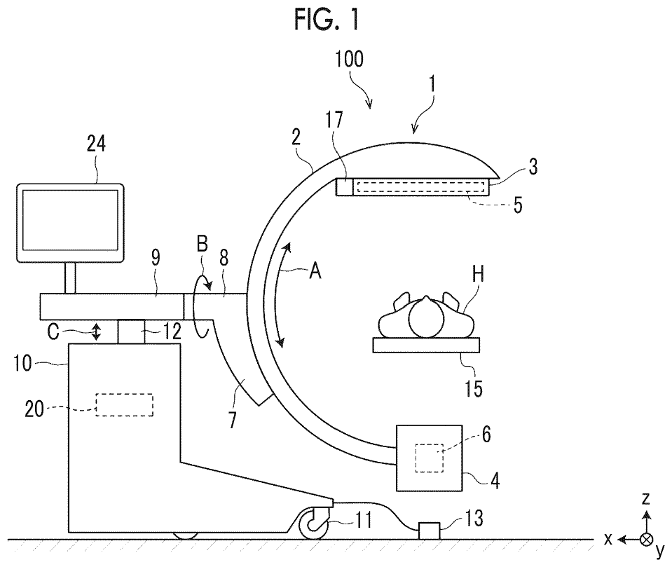

Hereinafter, embodiments of the present disclosure will be described with reference to the drawings. FIG. 1 is a schematic block diagram showing a configuration of a fluoroscopy system including a fluoroscopy apparatus equipped with an information processing apparatus according to an embodiment of the present disclosure. As shown in FIG. 1, a fluoroscopy system 100 according to the present embodiment comprises a fluoroscopy apparatus 1.

As shown in FIG. 1, the fluoroscopy apparatus 1 according to the present embodiment comprises a C-arm 2. A detection unit 3 is attached to one end part of the C-arm 2, and a radiation emitting unit 4 is attached to the other end part of the C-arm 2 to face the detection unit 3.

A radiation detector 5, such as a flat panel detector, is provided in the detection unit 3. In addition, for example, a circuit board including a charge amplifier that converts a charge signal read out from the radiation detector 5 into a voltage signal, a sampling two correlation pile circuit that samples the voltage signal output from the charge amplifier, and an analog-digital (AD) conversion unit that converts the voltage signal into a digital signal is also provided in the detection unit 3. Further, in the present embodiment, the radiation detector 5 is used. On the other hand, the present embodiment is not limited to the radiation detector 5 as long as radiation can be detected and the radiation can be converted into an image. For example, a detection device such as an image intensifier can be used.

In the present embodiment, an optical camera 17 is attached to the detection unit 3 for capturing an optical image of a subject H on an imaging table 15. Specifically, the optical camera 17 is attached at a position where it can capture an image of the range of the subject detected by the radiation detector 5.

The radiation detector 5 can repeatedly perform recording and reading out of a radiation image, may be a so-called direct-type radiation detector that directly converts radiation such as X-rays into charges, or may be a so-called indirect-type radiation detector that converts radiation into visible light once and converts the visible light into a charge signal. As a readout method of a radiation image signal, it is desirable to use the following method: a so-called thin film transistor (TFT) readout method which reads out a radiation image signal by turning on and off a TFT switch; or a so-called optical readout method which reads out a radiation image signal by irradiating a target with readout light. On the other hand, the readout method is not limited thereto, and other methods may be used.

A radiation source 6 is accommodated in the radiation emitting unit 4, and the radiation source 6 emits radiation toward the detection unit 3. The radiation source 6 emits X-rays as radiation, and a timing at which the radiation source 6 emits radiation and a timing at which the radiation detector 5 detects the radiation are controlled by an imaging controller, which will be described later. In addition, the radiation generation conditions in the radiation source 6, that is, the selection of the material of the target and the filter, the tube voltage, the irradiation time, and the like are also controlled by the imaging controller.

The C-arm 2 according to the present embodiment is held by a C-arm holding part 7 to be movable in the direction of an arrow A shown in FIG. 1, and integrally changeable in angle with respect to the detection unit 3 and the radiation emitting unit 4 in the z direction (vertical direction) shown in FIG. 1. In addition, the C-arm holding part 7 includes a shaft part 8, and the shaft part 8 rotatably connects the C-arm 2 to a bearing 9. Thereby, the C-arm 2 is configured to be rotatable in the direction of an arrow B shown in FIG. 1 with the shaft part 8 as a rotation axis.

In addition, as shown in FIG. 1, the fluoroscopy apparatus 1 comprises a body part 10. A plurality of wheels 11 are attached to a bottom portion of the body part 10, and thus, the fluoroscopy apparatus 1 can be moved. A support shaft 12 that is expanded and contracted in a z-axis direction of FIG. 1 is provided on an upper portion of a housing of the body part 10 in FIG. 1. The bearing 9 is held on the upper portion of the support shaft 12 to be movable in the direction of an arrow C.

In addition, a foot switch 13 for turning on and off the emission of radiation from the radiation source 6 of the radiation emitting unit 4 is connected to the body part 10. In a case in which a doctor during operation steps on the foot switch 13, it is turned on, and as a result, radiation is emitted from the radiation source 6. In a case in which the doctor removes his/her foot from the foot switch 13, it is turned off, and as a result, the emission of the radiation from the radiation source 6 is stopped.

The fluoroscopy apparatus 1 has the above-described configuration, and thus, irradiates the subject H from below the subject H on the imaging table 15 with radiation, detects the radiation transmitted through the subject H with the radiation detector 5 of the detection unit 3, and acquires a fluoroscopic image of the subject H.

Here, the C-arm 2 is movable in the direction of the arrow A, the direction of the arrow B, and the direction of the arrow C, and the fluoroscopy apparatus 1 is movable by the wheels 11. Therefore, the fluoroscopy apparatus 1 can image a desired part of the subject H on the imaging table 15 in a desired direction while adjusting their own positions and the position of the C-arm 2.

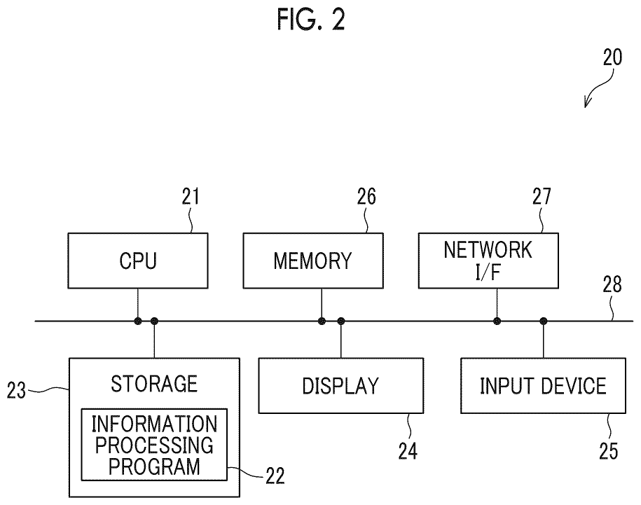

The body part 10 incorporates an information processing apparatus 20 according to the present embodiment for controlling imaging by the fluoroscopy apparatus 1 and for performing various processes for the fluoroscopy apparatus 1. FIG. 2 is a diagram showing a hardware configuration of the information processing apparatus. As shown in FIG. 2, the information processing apparatus 20 is a computer, such as a workstation, a server computer, and a personal computer, and comprises a central processing unit (CPU) 21, a non-volatile storage 23, and a memory 26 as a temporary storage area. In addition, the information processing apparatus 20 comprises a display 24, such as a liquid crystal display, an input device 25 such as a keyboard and a mouse, and a wired or wireless interface (I/F) 27 that is connected to the detection unit 3, the radiation emitting unit 4, and the foot switch 13, and is used to exchange information with external devices. The CPU 21, the storage 23, the display 24, the input device 25, the memory 26, and the I/F 27 are connected to a bus 28. The CPU 21 is an example of a processor according to an aspect of the present disclosure.

The storage 23 is realized by a hard disk drive (HDD), a solid-state drive (SSD), a flash memory, and the like. An information processing program 22 installed in the information processing apparatus 20 is stored in the storage 23 serving as a storage medium. The CPU 21 reads out the information processing program 22 from the storage 23, loads the information processing program 22 into the memory 26, and executes the loaded information processing program 22.

The information processing program 22 is stored in a storage device of a server computer connected to the network or in a network storage in a state in which it can be accessed from the outside, and is downloaded to and installed on the information processing apparatus 20 in response to a request. Alternatively, the information processing program 22 is recorded on a recording medium, such as a digital versatile disc (DVD) and a compact disc read-only memory (CD-ROM), and distributed, and is installed on the information processing apparatus 20 from the recording medium.

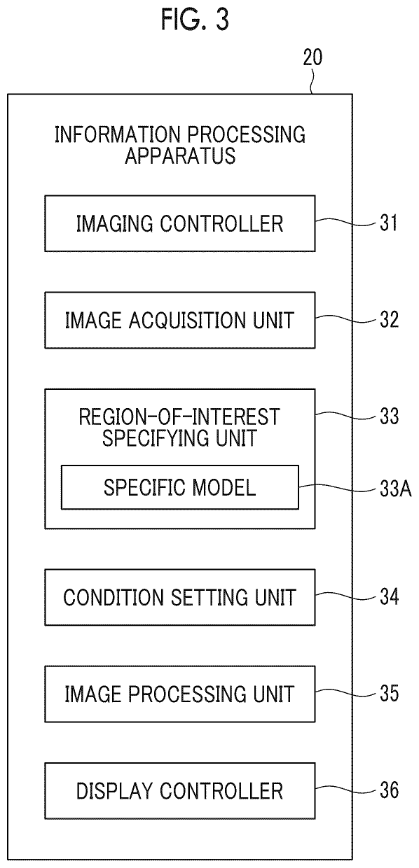

Next, a functional configuration of the information processing apparatus according to the present embodiment will be described. FIG. 3 is a diagram showing a functional configuration of the information processing apparatus according to the present embodiment. As shown in FIG. 3, the information processing apparatus 20 comprises an imaging controller 31, an image acquisition unit 32, a region-of-interest specifying unit 33, a condition setting unit 34, an image processing unit 35, and a display controller 36. Then, the CPU 21 executes the information processing program 22, whereby the CPU 21 functions as the imaging controller 31, the image acquisition unit 32, the region-of-interest specifying unit 33, the condition setting unit 34, the image processing unit 35, and the display controller 36.

In a case in which the foot switch 13 is turned on and an on signal from the foot switch 13 is input, the imaging controller 31 causes radiation to be emitted from the radiation source 6 included in the radiation emitting unit 4 based on imaging conditions set by a console (not shown). Furthermore, the imaging controller 31 detects the radiation transmitted through the subject H with the radiation detector 5 of the detection unit 3 in response to the timing at which the radiation is emitted from the radiation source 6, and generates a fluoroscopic image of the subject H. The generated fluoroscopic image is displayed on the display 24 via the display controller 36.

In the present embodiment, the imaging controller 31 controls the radiation source 6 to emit the radiation in a pulsed manner while the foot switch 13 is turned on. Accordingly, the pulsed radiation is emitted from the radiation source 6, and the fluoroscopic image is generated by the radiation detector 5 at a timing corresponding to the emission of the radiation. Therefore, the fluoroscopic images are continuously displayed on the display 24 like a moving image at a timing corresponding to the emission of the pulsed radiation.

In the present embodiment, the imaging controller 31 causes the optical camera 17 to acquire an optical image G0 of the subject H during operation while fluoroscopy is being performed. In the optical camera 17, the optical image G0 is generated as a moving image at a predetermined frame rate.

The image acquisition unit 32 acquires a fluoroscopic image T0 generated by the radiation detector 5 and the optical image G0 generated by the optical camera 17.

The region-of-interest specifying unit 33 specifies a region of interest included in the optical image G0. The region of interest is a region in the optical image G0 that includes the part to be a target of operation. The region-of-interest specifying unit 33 for specifying the region of interest uses a specific model 33A.

In a case in which the optical image G0 is input, the specific model 33A segments the optical image G0. That is, the specific model 33A specifies the subject region included in the optical image G0 and recognizes what the subject is. To this end, the specific model 33A is constructed by applying machine learning to segment the optical image G0. In machine learning, a subject region is specified, and a large amount of training data including labels indicating what the subject region is is used.

The region-of-interest specifying unit 33 uses the results acquired by the specific model 33A segmenting the optical image G0 to determine whether or not the optical image G0 includes another subject region other than the region of interest. In a case in which it is determined that no other subject regions are included, the region-of-interest specifying unit 33 specifies the subject region recognized by segmentation as the region of interest. In a case in which it is determined that another subject region is included, the region-of-interest specifying unit 33 specifies the region of interest based on a result of the segmentation. It is preferable that the type of region of interest to be specified can be set in advance in the information processing apparatus 20.

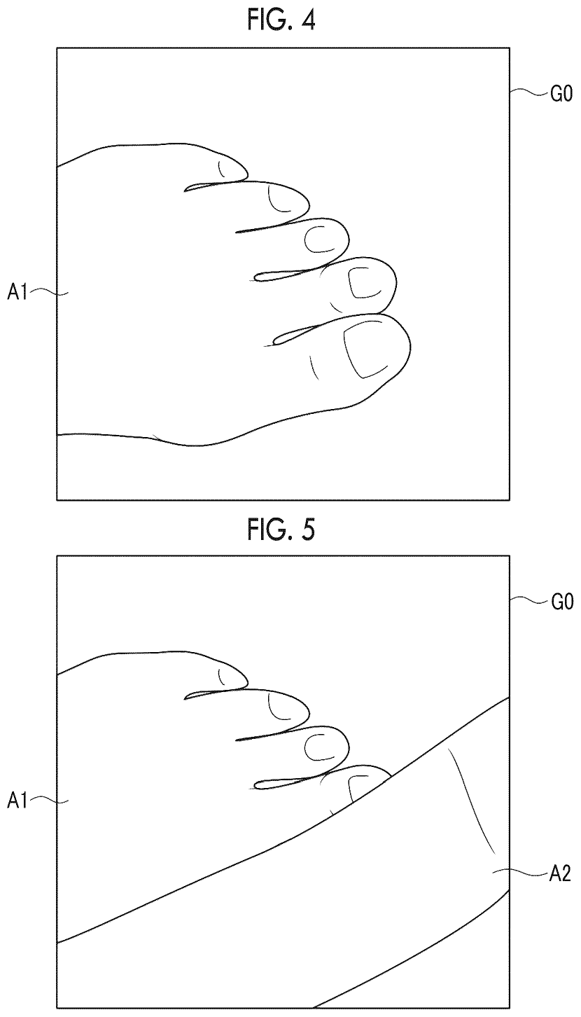

FIGS. 4 and 5 are diagrams for describing the specification of the region of interest. It is assumed that the region of interest is set to a foot. As shown in FIG. 4, in a case in which the optical image G0 includes only a person's foot, a subject region A1 included in the optical image G0 is recognized as a person's foot through segmentation. In this case, the region-of-interest specifying unit 33 determines, based on the result of the segmentation, that the optical image G0 does not include another subject region other than the region of interest. Then, the region-of-interest specifying unit 33 specifies the subject region A1 included in the optical image G0 as the region of interest.

On the other hand, as shown in FIG. 5, there is a case in which the optical image G0 includes a subject region A2 of the surgeon's arm in addition to the subject region A1 of the person's foot. In this case, the subject region A1 included in optical image G0 is recognized as a person's foot and the subject region A2 as an arm through segmentation. The region-of-interest specifying unit 33 determines, based on the result of the segmentation, that the optical image G0 includes another subject region other than the region of interest. Then, the region-of-interest specifying unit 33 specifies the subject region A1 included in the optical image G0 as the region of interest based on the result of the segmentation.

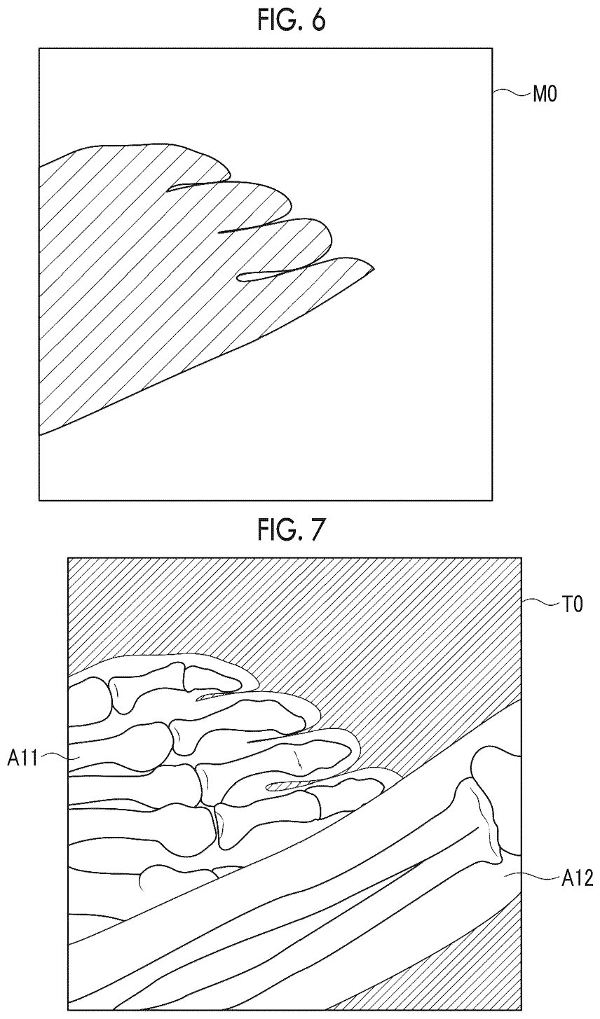

The condition setting unit 34 sets an image processing condition for improving the image quality of the region of interest in the fluoroscopic image T0. To this end, the condition setting unit 34 first specifies a region of interest in the fluoroscopic image T0. The condition setting unit 34 creates a map for the region of interest specified in the optical image G0 by the region-of-interest specifying unit 33. For example, a map is generated in which the value of the subject region A1, which is the region of interest in the optical image G0, is 1, and the value of the region other than the subject region A1 is 0. FIG. 6 is a diagram showing the generated map. As shown in FIG. 6, in a map MO, the subject region A1 corresponding to the region of interest in the optical image G0 is masked.

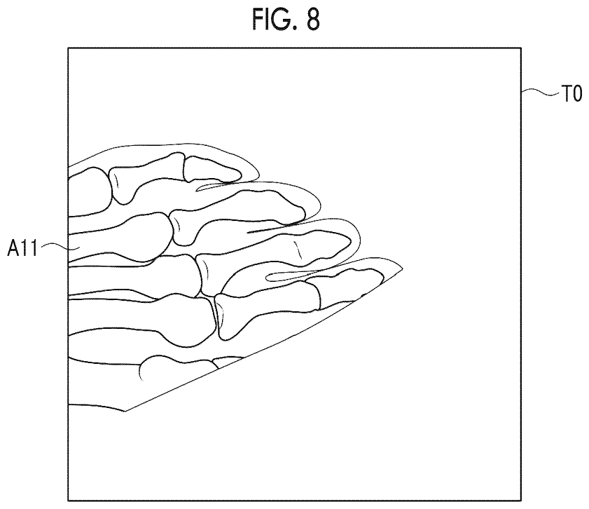

In the present embodiment, the optical image G0 and the fluoroscopic image T0 are acquired at the same timing. Further, the optical camera 17 is attached at a position where it can capture an image of the range of the subject detected by the radiation detector 5. Therefore, by applying the map MO derived from the optical image G0 to the fluoroscopic image T0, a region of interest in the fluoroscopic image T0 can be specified. FIGS. 7 and 8 are diagrams for describing the specification of a region of interest in the fluoroscopic image T0. As shown in FIG. 7, the fluoroscopic image T0 includes a foot region A11 and an arm region A12. By applying the map MO to the fluoroscopic image T0 shown in FIG. 7, the foot region A11 in the fluoroscopic image T0 is specified as a region of interest as shown in FIG. 8.

The condition setting unit 34 sets an image processing condition for improving a contrast of the region of interest specified in the fluoroscopic image T0. For example, the condition setting unit 34 creates a histogram of the image data in the region of interest in the fluoroscopic image T0, and sets a contrast transformation coefficient as an image processing condition such that the contrast of the region of interest falls within a brightness range that can be displayed by the display 24, based on the histogram.

The image processing unit 35 performs image processing on the fluoroscopic image T0 according to the image processing condition set by the condition setting unit 34, and derives a processed fluoroscopic image T1.

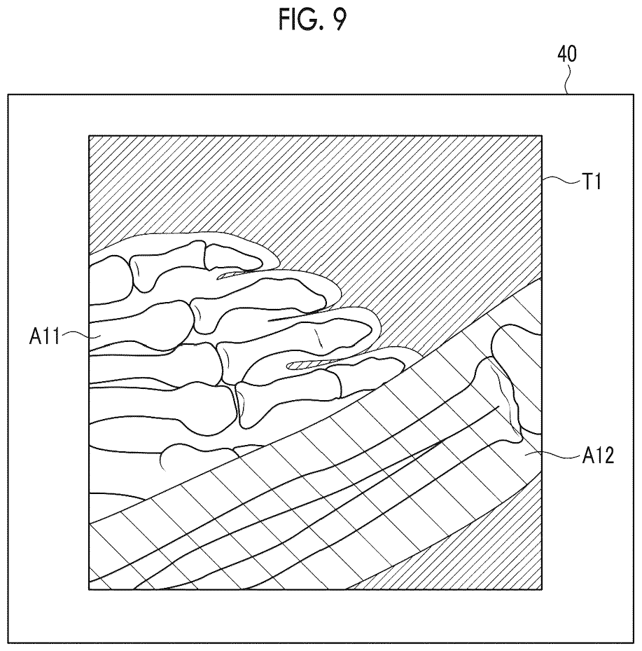

The display controller 36 displays the processed fluoroscopic image T1 on the display 24. FIG. 9 is a diagram showing the processed fluoroscopic image T1 displayed on the display 24. As shown in FIG. 9, the processed fluoroscopic image T1 is displayed on a display screen 40. In the processed fluoroscopic image T1, the contrast of the foot region A11 is improved, and the contrast of the arm region A12 of the surgeon is lower than the contrast of the foot region A11. In FIG. 9, the fact that the contrast of the arm region A12 of the surgeon is lower than the contrast of the foot region A11 is shown by hatching being applied to the arm region A12.

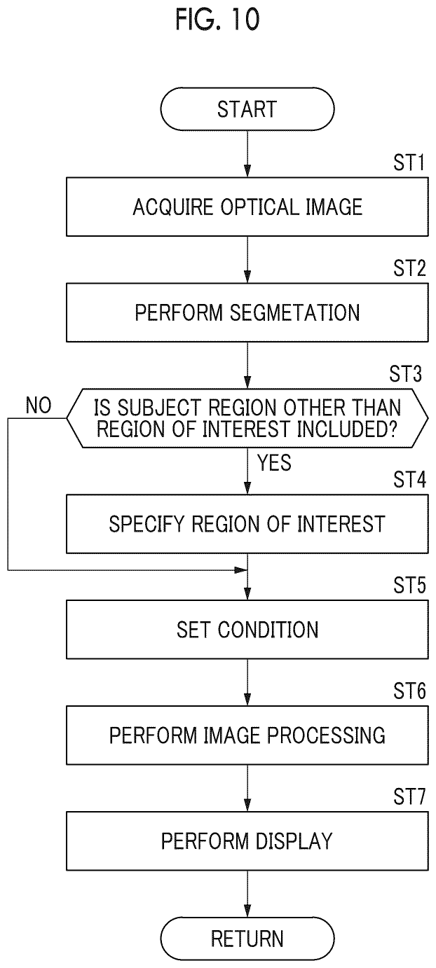

Next, processing performed in the present embodiment will be described. FIG. 10 is a flowchart showing a process performed in the present embodiment. In this case, the process will be described in a state in which the foot switch 13 is turned on and fluoroscopy is being performed. First, the imaging controller 31 acquires a fluoroscopic image T0, and in parallel with this, the optical image G0 generated by the optical camera 17 is acquired (Step ST1). Next, the region-of-interest specifying unit 33 segments the optical image G0 (Step ST2), and determines whether or not the optical image G0 includes a subject region other than the region of interest based on a result of the segmentation (Step ST3). In a case in which the determination in Step ST3 is affirmative, the region-of-interest specifying unit 33 specifies the region of interest based on the result of the segmentation (Step ST4). Then, the condition setting unit 34 sets an image processing condition for improving the image quality of the region corresponding to the region of interest in the fluoroscopic image T0 (Step ST5). In a case in which the determination in Step ST3 is negative, the process proceeds to Step ST5.

Next, the image processing unit 35 performs image processing on the fluoroscopic image TO based on the image processing condition set by the condition setting unit 34 to derive a processed fluoroscopic image T1 (Step ST6), and the display controller 36 displays the processed fluoroscopic image T1 on the display 24 (Step ST7), and the process returns to Step ST1.

In this manner, in the present embodiment, a region of interest included in an optical image is specified, an image processing condition is set to improve the image quality of a region in the fluoroscopic image corresponding to the region of interest, and image processing is performed on the fluoroscopic image based on the image processing condition. Therefore, even in a case in which the fluoroscopic image includes unnecessary subject regions other than the region of interest, a high-image quality fluoroscopic image including the region of interest can be acquired.

In the above embodiment, the condition setting unit 34 sets the image processing condition for improving the image quality of the region of interest, but the present disclosure is not limited thereto. In addition to or instead of setting the image processing condition, an imaging condition may be set. For example, as described above, in the case in which the fluoroscopic image T0 includes the subject region A1 of the foot, which is the region of interest, and the subject region A2 of the surgeon's arm, the foot has a smaller body thickness than the arm. For this reason, the condition setting unit 34 sets the imaging conditions to lower the tube voltage. In this case, the imaging controller 31 controls a radiation source 6 to emit radiation according to the set imaging conditions. Accordingly, the radiation dose in the arm region in the fluoroscopic image T0 is low, and the contrast is reduced, making it difficult to see. On the other hand, since the foot region is irradiated with an appropriate dose of radiation, the contrast of the foot region, which is the region of interest included in the fluoroscopic image T0, can be improved.

In addition, in the above embodiment, the radiation source 6 emits the radiation in a pulsed manner, but the present disclosure is not limited thereto. Radiation may be continuously emitted while the foot switch 13 is turned on.

In addition, the radiation in the embodiment described above is not particularly limited, and α-rays or γ-rays can be applied in addition to X-rays.

Further, in above embodiment, for example, as hardware structures of processing units that execute various kinds of processing, such as the imaging controller 31, the image acquisition unit 32, the region-of-interest specifying unit 33, the condition setting unit 34, the image processing unit 35, and the display controller 36, various processors shown below can be used. As described above, the various processors include a programmable logic device (PLD) as a processor of which the circuit configuration can be changed after manufacture, such as a field-programmable gate array (FPGA), a dedicated electrical circuit as a processor having a dedicated circuit configuration for executing specific processing such as an application-specific integrated circuit (ASIC), and the like, in addition to the CPU as a general-purpose processor that functions as various processing units by executing software (program).

One processing unit may be configured by one of the various processors, or may be configured by a combination of the same or different types of two or more processors (for example, a combination of a plurality of FPGAs or a combination of the CPU and the FPGA). In addition, a plurality of processing units may be configured by one processor.

As an example where a plurality of processing units are configured by one processor, first, there is a form in which one processor is configured by a combination of one or more CPUs and software as typified by a computer, such as a client or a server, and this processor functions as a plurality of processing units. Second, as represented by a system-on-chip (SoC) or the like, there is a form of using a processor for realizing the function of the entire system including a plurality of processing units with one integrated circuit (IC) chip. In this way, various processing units are configured by one or more of the above-described various processors as hardware structures.

Furthermore, as the hardware structure of the various processors, more specifically, an electrical circuit (circuitry) in which circuit elements such as semiconductor elements are combined can be used.

The supplementary notes of the present disclosure will be described below.

### Supplementary Note 1

An information processing apparatus in a fluoroscopy apparatus equipped with an optical camera that acquires a fluoroscopic image by performing fluoroscopy on a subject and acquires an optical image of the subject, the information processing apparatus comprising:
at least one processor,
in which the processor is configured to:
   specify a region of interest included in the optical image;
   set an image processing condition for improving an image quality of a region in the fluoroscopic image corresponding to the region of interest; and
   perform image processing on the fluoroscopic image based on the image processing condition.

### Supplementary Note 2

The information processing apparatus according to Supplementary Note 1,
in which the processor is configured to:
   determine whether or not the optical image includes another subject region other than the region of interest; and
   in a case in which it is determined that the optical image includes the other subject region, specify the region of interest included in the optical image, set the image processing condition, and perform the image processing.

### Supplementary Note 3

The information processing apparatus according to Supplementary Note 2,
in which the processor is configured to:
   segment the optical image using a trained model that has been trained to segment the optical image; and
   use a result of the segmentation to determine whether or not the other subject region is included and to specify the region of interest.

### Supplementary Note 4

The information processing apparatus according to Supplementary Note 2 or 3,
in which the other subject region includes a part of a body region of a surgeon who performs a treatment on the subject.

### Supplementary Note 5

The information processing apparatus according to Supplementary Note 1,
in which the processor is configured to, in a case in which it is determined that the optical image includes only one subject region, specify the one subject region as the region of interest, set the image processing condition, and perform the image processing.

### Supplementary Note 6

The information processing apparatus according to any one of Supplementary Notes 1 to 5,
in which the image processing condition is an image processing condition for improving a contrast of the region of interest included in the fluoroscopic image.

### Supplementary Note 7

The information processing apparatus according to any one of Supplementary Notes 1 to 6,
in which the processor is configured to:
   set an imaging condition for improving the image quality of the region in the fluoroscopic image corresponding to the region of interest in the case of performing the fluoroscopy; and
   perform the fluoroscopy based on the imaging condition.

### Supplementary Note 8

The information processing apparatus according to Supplementary Note 7,
in which the imaging condition is an imaging condition for improving a contrast of the region of interest included in the fluoroscopic image.

### Supplementary Note 9

The information processing apparatus according to any one of Supplementary Notes 1 to 8,
in which the processor is configured to display, on a display, a processed fluoroscopic image on which the image processing is performed.

### Supplementary Note 10

An information processing method in a fluoroscopy apparatus equipped with an optical camera that acquires a fluoroscopic image by performing fluoroscopy on a subject and acquires an optical image of the subject, the information processing method comprising:
via a computer,
specifying a region of interest included in the optical image;
setting an image processing condition for improving an image quality of a region in the fluoroscopic image corresponding to the region of interest; and
performing image processing on the fluoroscopic image based on the image processing condition.

### Supplementary Note 11

An information processing program causing a computer to execute information processing in a fluoroscopy apparatus equipped with an optical camera that acquires a fluoroscopic image by performing fluoroscopy on a subject and acquires an optical image of the subject, the information processing program causing the computer to execute:
a procedure of specifying a region of interest included in the optical image;
a procedure of setting an image processing condition for improving an image quality of a region in the fluoroscopic image corresponding to the region of interest; and
a procedure of performing image processing on the fluoroscopic image based on the image processing condition.

What is claimed is:

1. An information processing apparatus in a fluoroscopy apparatus equipped with an optical camera that acquires a fluoroscopic image by performing fluoroscopy on a subject and acquires an optical image of the subject, the information processing apparatus comprising:
at least one processor,
wherein the processor is configured to:
specify a region of interest included in the optical image;
set an image processing condition for improving an image quality of a region in the fluoroscopic image corresponding to the region of interest; and
perform image processing on the fluoroscopic image based on the image processing condition.

2. The information processing apparatus according to claim 1,
wherein the processor is configured to:
determine whether or not the optical image includes another subject region other than the region of interest; and
in a case in which it is determined that the optical image includes the other subject region, specify the region of interest included in the optical image, set the image processing condition, and perform the image processing.

3. The information processing apparatus according to claim 2,
wherein the processor is configured to:
segment the optical image using a trained model that has been trained to segment the optical image; and
use a result of the segmentation to determine whether or not the other subject region is included and to specify the region of interest.

4. The information processing apparatus according to claim 2,
wherein the other subject region includes a part of a body region of a surgeon who performs a treatment on the subject.

5. The information processing apparatus according to claim 3,
wherein the other subject region includes a part of a body region of a surgeon who performs a treatment on the subject.

6. The information processing apparatus according to claim 1,
wherein the processor is configured to, in a case in which it is determined that the optical image includes only one subject region, specify the one subject region as the region of interest, set the image processing condition, and perform the image processing.

7. The information processing apparatus according to claim 1,
wherein the image processing condition is an image processing condition for improving a contrast of the region of interest included in the fluoroscopic image.

8. The information processing apparatus according to claim 4,
wherein the image processing condition is an image processing condition for improving a contrast of the region of interest included in the fluoroscopic image.

9. The information processing apparatus according to claim 5,
wherein the image processing condition is an image processing condition for improving a contrast of the region of interest included in the fluoroscopic image.

10. The information processing apparatus according to claim 1,
wherein the processor is configured to:
set an imaging condition for improving the image quality of the region in the fluoroscopic image corresponding to the region of interest in the case of performing the fluoroscopy; and
perform the fluoroscopy based on the imaging condition.

11. The information processing apparatus according to claim 4,
wherein the processor is configured to:
set an imaging condition for improving the image quality of the region in the fluoroscopic image corresponding to the region of interest in the case of performing the fluoroscopy; and
perform the fluoroscopy based on the imaging condition.

12. The information processing apparatus according to claim 5,
wherein the processor is configured to:
set an imaging condition for improving the image quality of the region in the fluoroscopic image corresponding to the region of interest in the case of performing the fluoroscopy; and
perform the fluoroscopy based on the imaging condition.

13. The information processing apparatus according to claim 10,
wherein the imaging condition is an imaging condition for improving a contrast of the region of interest included in the fluoroscopic image.

14. The information processing apparatus according to claim 11,
wherein the imaging condition is an imaging condition for improving a contrast of the region of interest included in the fluoroscopic image.

15. The information processing apparatus according to claim 12,
wherein the imaging condition is an imaging condition for improving a contrast of the region of interest included in the fluoroscopic image.

16. The information processing apparatus according to claim 1,
wherein the processor is configured to display, on a display, a processed fluoroscopic image on which the image processing is performed.

17. The information processing apparatus according to claim 4,
wherein the processor is configured to display, on a display, a processed fluoroscopic image on which the image processing is performed.

18. The information processing apparatus according to claim 5,
wherein the processor is configured to display, on a display, a processed fluoroscopic image on which the image processing is performed.

19. An information processing method in a fluoroscopy apparatus equipped with an optical camera that acquires a fluoroscopic image by performing fluoroscopy on a subject and acquires an optical image of the subject, the information processing method comprising:
via a computer,
specifying a region of interest included in the optical image;
setting an image processing condition for improving an image quality of a region in the fluoroscopic image corresponding to the region of interest; and
performing image processing on the fluoroscopic image based on the image processing condition.

20. A non-transitory computer-readable storage medium that stores an information processing program causing a computer to execute information processing in a fluoroscopy apparatus equipped with an optical camera that acquires a fluoroscopic image by performing fluoroscopy on a subject and acquires an optical image of the subject, the information processing program causing the computer to execute:
a procedure of specifying a region of interest included in the optical image;
a procedure of setting an image processing condition for improving an image quality of a region in the fluoroscopic image corresponding to the region of interest; and
a procedure of performing image processing on the fluoroscopic image based on the image processing condition.
